(19) United States
(12) Patent Application Publication
(10) Pub. No.: US 2003/0140235 A1
(43) Pub. Date: Jul. 24, 2003

(54) Method for biometric encryption of email

(76) Inventors: Guy Immega, Vancouver (CA); Timothy Dale Vlaar, Vancouver (CA); Geoffrey Vanderkooy, Waterloo (CA); Kim Tucker, Vancouver (CA)

Correspondence Address: PAUL A. GUSS, PAUL A. GUSS ATTORNEY AT LAW, 775 S 23RD ST FIRST FLOOR SUITE 2, ARLINGTON, VA, 22202

(21) Appl. No.: 10/307,424

(22) Filed: Dec. 2, 2002

Related U.S. Application Data
(63) Continuation-in-part of application No. 09/588,971, filed on Jun. 2, 2000.

(51) Int. Cl. H04L 9/00

(52) U.S. Cl. 713/186

(57) ABSTRACT

A method for permitting the secure transmission of electronic messages by using biometric certification is provided. Enrolled fingerprint feature sets, which have been uniquely modified for a particular person with whom messages will be exchanged, are cross-enrolled between the sender and receiver such that the biometric identity of both the sender and receiver can be checked during message sending and receiving. In one embodiment, the sender provides a live-scan fingerprint feature set which is subtracted from the enrolled fingerprint feature set of the sender to create a “difference key” or “difference key” that is used to encrypt the message and other fingerprint data. The receiver decrypts the sender's live-scan fingerprint feature set that is then used to reconstruct the difference key, which is then used to decrypt the message.

This is a continuation-in-part of U.S. application Ser. No. 09/588,971 and a continuation of International Application PCT/CA01/00812.

### TECHNICAL FIELD

This invention relates to a method of certifying the identity of both the sender and the receiver of electronic messages by means of biometric information such as fingerprints.

### BACKGROUND

Related art includes U.S. Pat. No. 5,541,994: (“the '994 patent”) which issued Jul. 30, 1996 for an invention called “Fingerprint controlled public key cryptographic system.” The '994 patent shows a fingerprint used to generate a unique number for generating public and private keys by manipulation of the fingerprint image data. A filter is generated from the Fourier transform of the fingerprint and the unique number; the filter is later used with the Fourier transform of the fingerprint and a spatial light modulator to retrieve the unique number and decrypt a message. Unlike the present invention, the '994 patent depends on filters, Fourier transforms and optical computing techniques.

Related art also includes U.S. Pat. No. 5,712,912: (“the '912 patent”) which issued Jan. 27, 1998 for an invention called “Method and apparatus for securely handling a personal identification number or cryptographic key using biometric techniques.” The '912 patent is for a method and apparatus using biometric information (such as a fingerprint, an iris structure, etc.) as a cipher for encrypting and decrypting a personal identification number (PIN). To decrypt the PIN, a full-complex spatial light modulator is illuminated with an optical beam carrying the Fourier transform of the biometric image of an individual fingerprint to be identified. Unlike the present invention, the '912 patent depends on Fourier transforms and optical computing techniques and the method for encrypting the PIN is not specified.

Related art also includes U.S. Pat. No. 5,737,420: (“the '420 patent”) which issued Apr. 7, 1998 for an invention called “Method for secure data transmission between remote stations.” The '420 patent is for a method for permitting the secure handling or data between two remote stations firstly involves the generation of an encrypted decryption key which is based on a fingerprint information signal from a user of a first station, a fingerprint information signal from a user of a second station, and a key representing function derived from a random key. The encrypted decryption key is of the type with the property that when it is written to a spatial light modulator (SLM) of an optical correlator, the output of the correlator is similar when input with either one of the fingerprint information signals. A message encrypted with the key may be decrypted at either station by retrieving the encrypted key, writing the encrypted key to a filter of an optical correlator, inputting one of the fingerprint information signals to the correlator in order to allow recovery of the decryption key, and applying the decryption key to the encrypted message. Unlike the present invention, the '420 patent depends on filters, and optical computing techniques. Other related art includes U.S. Pat. No. 6,035,398 and U.S. Pat. No. 5,514,994.

### SUMMARY OF THE INVENTION

The invention describes an algorithmic method to provide biometric security to electronic messages, such as electronic mail (also known as email), certifying the physical identity of both the sender and receiver. The World Wide Web or Internet allows any computer workstation to communicate with any other workstation through a variety of network connections. One common form of network communications is electronic mail or “email,” which is now a widely used communications means. However, email Is generally not secure or private. Although public key/private key encryption tools are available, such as PGP (Pretty Good Privacy), such encryption is slow and does not securely link a message to the identity of the sender or confirm that the correct person has viewed it. Digital certificates can help verify the origin of a message, but not generally the personal identity of the recipient. Fingerprint biometrics (or any other biometric) can be used to add convenient security to email, by augmenting public key or other encryption and/or replacing digital certificates.

All embodiments of the present invention employ biometric feature sets, also known as templates, which are well known to those skilled in the art of biometric identification. A biometric feature set is any biometric Identifier file that includes sufficient salient aspects of the biometric to allow identification of the individual person. For example, a fingerprint feature set may typically be comprised of “minutiae”, which are usually understood to be the locations and orientations of bifurcations and terminations of fingerprint ridges. However, any other features of the fingerprint may also be included in a fingerprint feature set such as curvature, ridge count, ridge distance curvature between points, or the shape of patterns in the fingerprint. In a similar fashion, a biometric feature set for any other type of biometric system, such as those based on the details of the iris of the human eye or the dimensions of the human hand, may be employed.

The present invention requires both the sender and the receiver to cross-enroll biometric feature sets. Alternatively, the sender and receiver may enroll biometric feature sets on a server connected to a network. For fingerprint enabled messaging, the objectives are that the sender must be confident that only the intended individual is able to decode the message, and the receiver must be confident that the message originated from a known sender. Therefore, both sender and receiver must be equipped with a fingerprint sensor and must be cross-enrolled on each other's computer or other Information processing device; alternatively both the sender and receiver must be enrolled on a network server. This allows confirmation of identity of both parties at both ends of a message exchange. In addition, it allows user-specific encryption of messages. Cross-enrollment depends on public key Infrastructure (PKI) cryptography (or other asymmetric public/private key cryptography), or the use of a secret key to transmit or deliver a biometric identifier file, which is a user's “enrolled fingerprint feature set” (typically a minutiae file) that has been uniquely modified for each recipient so that only the designated individual can employ it for messaging. Both the sender and the receiver must store the modified enrolled feature sets of the other individual with whom secure messages will be exchanged, or the modified enrolled feature sets must be stored on a network server. A modified enrolled fingerprint feature set is only slightly changed, so that it still can be used to match fingerprints and identify an individual.

In the first embodiment of the invention, the sender will compose a message, which may include additional files or data of any type attached to the message. The sender will then initiate sending the message with a live-scan of the sender's fingerprint, which is then stored as a live-scan fingerprint feature set. The stored modified enrolled fingerprint feature set of the sender (which was previously sent to the receiver during cross-enrollment) is then retrieved (or derived again); the sender's two fingerprint feature sets are then used to derive the sender's “difference key” or “hidden key”. The sender's live-scan feature set is then encrypted using the public key of the receiver The “difference key” is then used to encrypt the modified enrolled fingerprint feature set of the receiver (which has previously been cross-enrolled and stored on the sender's hard drive). The “difference keys” is also used to encrypt the message. When the message is sent it will have four parts, 1) an unencrypted header (just as a standard email does); 2) the sender's live-scan fingerprint feature set (encrypted using the receiver's public key); 3), the receiver's enrolled feature set (encrypted with the “difference key”), and; 4) the message itself (also encrypted with “difference key”).

All embodiments of this invention employ a novel “difference key” which is a highly secure biometric “hidden key” derived from two encrypted fingerprint feature sets which are sent at different times (one during cross-enrollment and one with the message). The “difference key” is never sent or exchanged between the sender and the receiver, but is always derived during the decryption process. In the preferred embodiments, the “difference key” is derived from the live-scan (real-time) fingerprint feature set of the sender and the stored modified enrolled fingerprint feature set of the sender. A difference key may also be derived from information subsets of fingerprint feature sets. The “difference key” is therefore truly random, since it embodies variations in how a live-scan fingerprint is presented to the sensor.

The “difference key” is calculated from the difference between the fingerprint feature set of a live-scan of the sender (collected at the time of sending the message) and the modified enrolled fingerprint feature set of the sender (which was previously sent to the receiver during cross-enrollment). The “difference key” is thus a precise number (or set of numbers) that is used as a secret encryption or decryption key for the actual message. Each “difference key” is unique and can be calculated only at the point of origin and at the point of reception of the message, and can be made invisible to both sender and receiver. The “difference key” is also specific to the message being sent and thus is usable one time only.

Upon receiving the electronic message, the receiver will use a fingerprint to activate the process of decoding of the message; a match of the receiver's live-scan fingerprint feature set will enable retrieval of the receiver's private key, which is used to decrypt sender's live-scan fingerprint feature set (which was encrypted using the receiver's public key). The sender's live-scan fingerprint feature set is then matched against the stored modified enrolled fingerprint feature set of the sender (which was previously sent to the receiver during cross-enrollment), validating the identity of the sender.

Once the sender's identity is confirmed, the “difference key” is reconstructed by subtracting the sender's live-scan fingerprint feature set from the sender's modified enrolled fingerprint feature set. The “difference key” is then used to decrypt the receiver's modified enrolled fingerprint feature set (which was received with the message—not the original unmodified version stored on the receiver's hard drive). A second confirmation of the sender's identity is optionally performed by comparing the decrypted receiver's modified enrolled fingerprint feature set with the stored receiver's modified enrolled fingerprint feature set (which was sent to the sender during cross-enrollment and is specific to the sender); the second confirmation of the identity of the sender provides additional protection against identity theft fraud.

It is essential that the sender's message should only be readable by the designated receiver. To ensure this, the feature set of the receiver's live-scan fingerprint feature set is matched against the decrypted modified enrolled fingerprint feature set of the receiver (received with the message), validating the receiver's identity for a second time. Once the receiver's identity is verified, the “difference key” is used to automatically decrypt the actual message, and make it available to the receiver.

An optional process allows for the sender to be given direct confirmation that the correct person has received the message, thus providing a kind of electronic “registered mail.” To provide affirmative acknowledgement of reception, the receiver's live-scan fingerprint feature set is encrypted, preferably with the “difference key” (or the sender's public key), and transmitted to the sender. The sender's computer can then automatically decrypt the receiver's live-scan fingerprint feature set with the “difference key” (or the sender's private key); the decrypted receiver's live-scan fingerprint feature set is then matched with modified enrolled fingerprint feature set of the receiver (which was previously cross-enrolled). A successful match of the live-scan fingerprint feature set of the receiver will allow a notification to be displayed to the sender that the message has been received and decrypted by the proper person.

In a second embodiment of the invention (which also depends on cross-enrollment of modified enrolled fingerprint feature sets of both the sender and the receiver), additional security is provided by a four stage process: two stages at sending and two stages at receiving; the sender must provide two fingerprints to send the message and the receiver must provide two fingerprints to receive the message. A “middle man” attack will require the attacker to know the private keys of both the sender and receiver, and also the modified enrolled fingerprint feature sets of both the sender and receiver; the attacker must also be able to intercept both sides of a multi-part message handshake in order to decode in near real time the live-scan fingerprint feature sets of both the sender and receiver, which are required to decode the “difference key's of both the sender and receiver.

The process is started when the sender generates a first live-scan fingerprint feature set and encrypts it with the public key of the receiver; the sender then transmits his/her encrypted first live-scan feature set to the receiver, announcing the intent to send a secure message. The receiver then checks the identity of the sender (for the first time) and responds by generating the receiver's first live-scan fingerprint feature set, which is then used to create a receiver's “difference key”. The receiver then encrypts his/her first live-scan fingerprint feature set with the sender's public key, and then encrypts the first live-scan fingerprint feature set of the sender with the receiver's “difference key”. Both encrypted feature sets are then sent to the sender, announcing the intent of the receiver to receive a secure message from the sender.

Upon receiving the feature sets from the receiver, the sender uses a private key (associated with the public key of the sender used by the receiver) to decrypt the first live-scan fingerprint feature set of the receiver. The receiver's identity is then checked (for the first time) by matching the receiver's first live-scan fingerprint feature set with the receiver's stored modified enrolled fingerprint feature set. The sender can then reconstruct the “difference key” of the receiver by subtracting the receiver's first live-scan fingerprint feature set from the receiver's stored modified enrolled fingerprint feature set. The “difference key” is used to decrypt the first live-scan fingerprint feature set of the sender, which allows confirmation of the receiver's identity (for the second time) by comparing it to the original first sender's live-scan fingerprint feature set. The public key of the receiver is then used to re-encrypt the first live-scan fingerprint feature set of the receiver (for later transmission). The sender then provides a second live-scan fingerprint and exacts a second live-scan feature set; this allows the creation of the “difference key” of the sender by subtracting the sender's live-scan fingerprint feature set from the sender's modified enrolled feature set (that was previously modified for the specific receiver and cross-enrolled with the receiver). The “difference key” is then used to encrypt both the message and the second live-scan fingerprint feature set of the sender. The sender then transmits to the receiver: the re-encrypted receiver's first live-scan fingerprint feature set, the encrypted message and the encrypted sender's second live-scan fingerprint feature set.

Upon receiving the encrypted message and feature sets, the receiver provides a second live-scan fingerprint and extracts a second live-scan fingerprint feature set, to initiate the decryption process; if the receiver's second live-scan fingerprint feature set does not match the receiver's stored enrolled fingerprint feature set, then the receiver is not valid and the decryption process stops. If the receiver's second live-scan fingerprint feature set is valid, the receiver then confirms the sender's identity (for a second time) by using a private key (associated with the receiver's public key used by sender) to decrypt the receiver's first live-scan fingerprint feature set, which is then matched against the original receiver's first live-scan fingerprint feature set. The receiver then reconstructs (or retrieves) the “difference key” of the receiver and decrypts the sender's second live-scan fingerprint feature set. The sender's identity is confirmed (for a third time) by matching the sender's second live-scan fingerprint feature set with the sender's stored modified enrolled fingerprint feature set (which was previously cross-enrolled with the receiver). The “difference key” of the sender is then reconstructed by subtracting the sender's second live-scan fingerprint feature set from the sender's stored modified enrolled fingerprint feature set. The “difference key” of the sender is then used to decrypt the message and display it to the receiver.

An optional process allows for the sender to be given direct confirmation that the correct person has received the message, thus providing a kind of electronic “registered mail.” To provide affirmative acknowledgement of reception, the receiver's second live-scan fingerprint feature set is encrypted, preferably with the “difference key” of the sender, and transmitted to the sender. The sender's computer can then automatically decrypt the receiver's second live-scan fingerprint feature set with the “difference key” of the sender; the decrypted receiver's second live-scan fingerprint feature set is then matched with modified enrolled fingerprint feature set of the receiver (which was previously cross-enrolled). A successful match of the second live-scan fingerprint feature set of the receiver will allow a notification to be displayed to the sender that the message has been received and decrypted by the proper person.

In a third embodiment of the invention, the “difference key” algorithm subroutine is adapted for use on a cellular telephone network. As an alternative to cross-enrollment, which may be impractical for cellular telephones, a secure Identity Server is maintained on the cellular network. The Identity Server has databases for names and numbers, public keys of network users, and fingerprint data of network users. The information in the Identity Server databases allow cellular telephone users to verify identity without storing any direct biometric information in the cell phone. The Identity Server can automatically provide biometric verification of the identity of other users on the cellular network, or to other entities externally connected to the network (such as banks or commercial corporations). The Identity Server can also provide biometric information, such as centroids and feature counts, which will allow remote cellular telephone users anywhere on the network to employ “difference keys” to encrypt or decrypt audio or other data from and to cellular telephones, allowing secure real-time communications.

In order to be registered on the Identity Server database, each cellular telephone on the network must be equipped with a biometric input device. such as a fingerprint sensor. The first time the cellular telephone is used, in a one-time registration procedure, the user must provide a biometric feature set (such as a fingerprint feature set) to the Identity Server database. To do this, the cellular telephone will first automatically generate PKI (public key infrastructure) or other asymmetric public and private keys for the particular telephone and user (or the PKI keys may be uploaded to the cellular telephone). The user then presents several fingerprints of the same finger, and the enrolled FP feature set is generated. A call is then placed to the Identity Server, which provides the PKI public key of the Identity Server (and also the asymmetric public signature key of the Identity Server, which is later used to verify the origin of messages from the Identity Server). The enrolled FP feature set of the user is then encrypted with the PKI public key of the Identity Server, and the feature set is then transmitted to the Identity Server along with the name, number and PKI public key of the user. Finally, all FP feature sets are deleted from the cellular telephone, leaving no biometric information on the telephone.

Once a user is registered on the Identify Server, secure calls may be placed to any other registered user on the cellular network. Optionally, a user may use a password to turn on the cellular telephone (which is standard option with many cellular telephones currently in service). The user must then simply dial the telephone number of another user (or receive a call) and present a fingerprint to the sensor on the cellular telephone. Three levels of security are therefore provided: 1) what the user knows (a password), 2) what the user possesses (the registered cellular telephone) and 3) the biometric of the user (a fingerprint).

When a user places or receives a call, the cellular telephone and the Identity Server will execute an algorithm to validate the identity both of the users on the call, and to provide streaming encryption and decryption of cellular telephone audio, or other data. The algorithm is designed to leave no direct biometric data on a cell phone, and to use minimal bandwidth for fingerprint data. No third party, including the Identity Server, can decrypt the conversation—all calls are uniquely encrypted and each user employs a separate encryption/decryption key.

The cellular telephone algorithm may be divided into five segments The first segment covers the two user actions needed to initiate or receive a cell phone call. In addition to the usual dialing sequence, the first user is required to present a fingerprint (which is automatically converted into a live-scan FP feature set). Nothing more is required of the first user.

In the second segment of the algorithm, the Identity Server provides confirmation of the Identity of both users in cellular telephone connection. Firstly the PKI public key of the Identity Server is used to encrypt the (unmodified) live-can FP feature set of the first user, which is then sent to the Identity Server. The Identity Server then decrypts live-scan FP feature set of the first user (using the private key of the Identity Server) and matches it against the stored enrolled FP feature set of the first user; a match will result in a secure message being sent to second user (who is talking with the first user) of identity validation of the first user. The second user will use a similar process, and the Identity Server will provide Identity validation of the second user to the first user. This process of identity validation of both cell phone users by the Identity Server, provides a basis for transaction security over a cell phone network. For example, it is possible for the Identity Server to notify other parties, including e-commerce vendors and banks, of the valid identity of a particular cell phone user.

In the third segment of the algorithm, the Identity Server provides part of the necessary data for creating a “difference key” for streaming encryption and decryption of telephone calls. The Identity Server will randomly modify the enrolled FP feature sets of both users, extract the centroids (or other derived information about the FP feature sets), double encrypt the centroids (with the private signature key of he Identity Server and the public keys of the users) and send the encrypted centroids to both of the users. [Alternatively, the Identity Server can extract the centroids (or other derived information about the FP feature sets) of the FP feature sets and then randomly modify the centroids and then double encrypt the centroids and send the encrypted centroids to both of the users.] The first user then receives and decrypts the centroid data of both users (by using the PKI private key of the first user and the public signature key of the Identity Server—thus verifying that the data originated from the proper Identity Server). The Identity Server also provides the encrypted public key of the second user (or any other user); the Identity Server is the only source of user public keys, further confirming that a false Identity Server is not being used.

The fourth segment of the cellular telephone algorithm creates the “difference key” of the first user, which is used for streaming encryption (scrambling) of audio generated by the first user. The live-scan FP feature set of the first user is then modified by using a random number; this modification of the live-scan feature set blocks the Identity Server from decrypting messages. The centroid (and/or other derived information such as feature count) of the modified live-scan FP feature set of the first user is then calculated. [Alternatively, the first user can extract the centroid (or other derived information) of the live-scan FP feature set and then randomly modify the centroid.] All versions of the live-scan FP feature sets of the first users are then deleted from the cell phone, leaving no biometric data on the phone. The centroid of the live-scan FP feature set of the first user is then encrypted with the public key of the second user and sent to the second user. The “difference key” of the first user is then created from the centroids of the live-scan and the enrolled FP feature sets of the first user. The “difference key” of the first user is then used for streaming encryption (scrambling) of the audio (or other data) generated by the first user, which is then transmitted to the second user. The difference key is used one time only for each call and is thus relatively secure.

The fifth segment of the cellular phone algorithm reconstructs the “difference key” of the second user, which is used for unscrambling audio generated by the second user. The first user receives from the second user the encrypted centroid of the modified live-scan FP feature set of second user (provided for the current call only), and decrypts It with the private key of the first user. The first user also recalls the previously decrypted centroid of the modified enrolled FP feature set of second user (received from the Identity Server). The “difference key” of the second user is then reconstructed from the centroids of the modified live-scan and the modified enrolled FP feature sets of second user. The “difference key” of the second user is then used for streaming decryption (unscrambling) of the audio from the second user.

### BRIEF DESCRIPTION OF FIGURES

Further objects, features and advantages of the present invention will become more readily apparent to those skilled in the art from the following description of the Invention when taken in conjunction with the accompanying drawings, in which:

FIG. 1 shows networked computers connected to the Internet, each computer having a biometric input device.

FIG. 2 shows an algorithm flow chart for cross-enrollment of biometric identifier information between two users.

FIG. 3A shows a sample algorithm flow chart for generating a modified enrolled fingerprint feature set.

FIG. 3B shows a sample algorithm flow chart for generating a secret “difference key” which is derived from two fingerprints and is used to encrypt and decrypt messages.

FIG. 4 shows an algorithm flow chart for sending a biometrically secured message in a single transmission.

FIG. 5 shows an algorithm flow chart for receiving a biometrically secured message in a single transmission.

FIG. 6 shows an algorithm flow chart for sending a biometrically secured message in two stages, and for receiving a biometrically secured message in two stages.

FIG. 7 shows an Identity Server database connected to a cellular telephone network.

FIG. 8 shows an algorithm flow chart for biometrically enrolling the user of a cellular telephone on a cellular network,

FIG. 9 shows an algorithm flow chart for a biometrically secured call on cellular network.

### DETAILED DESCRIPTION OF PREFERRED EMBODIMENTS

The terms “user”, “sender” or “receiver” in the context herein refers to the individual or to his/her computer or any device equipped to execute the steps described, depending on the context. Such other devices include cellular telephones, personal digital assistants and the like.

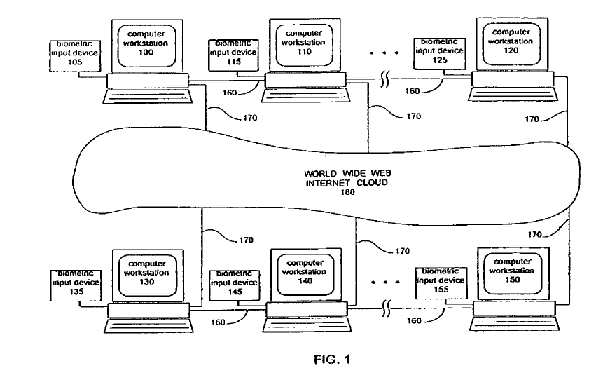

FIG. 1 shows computer workstations 100-150, which are networked directly 160 or connected 170 to the World Wide Web Internet “cloud” 180. Each workstation has a biometric input device 105-155, which can be a fingerprint sensor, or any other biometric input device such as an iris eye feature scanner, facial recognition sensor, voice recognition sensor, or any other biometric sensor. For all embodiments of the present invention, fingerprint biometrics are given as an example, but any other biometric identification system may be equally used. An individual person at any workstation 100-150 can send electronic mail, sometimes known as “email,” to any other person on a network 160 or over a connection 170 through the Internet 180. The fingerprint sensor provides a biometric input, unique to each individual, which can be used to certify identity of both the sender and the receiver for electronic messaging or “email.” Biometric certification can also be used to augment other known security means such as encryption using public key/private key systems.

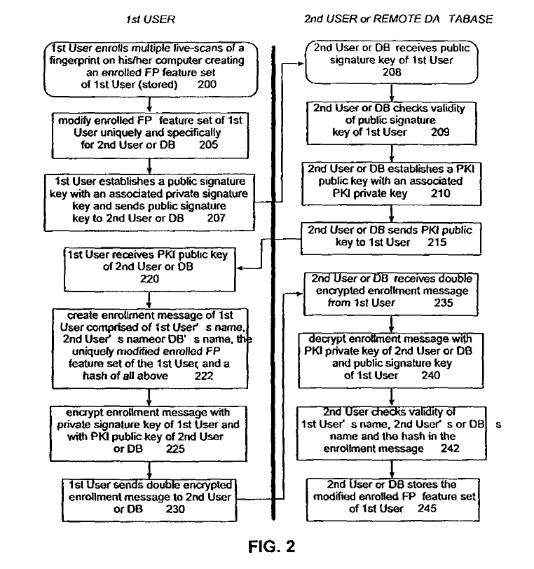

FIG. 2 provides an algorithmic flow chart for securely exchanging enrolled fingerprint feature sets between two users, for later use in biometrically certified messages. Both the sender and the receiver must be cross-enrolled on each other's computer to allow confirmation of identity of both parties at both ends of a message exchange. The process of cross-enrollment starts at step 200, where the first user enrolls a fingerprint on a computer system. Enrollment will typically use one or more fingerprints to attain a robust enrolled fingerprint feature get of the most significant features of the fingerprint for identification purposes. The first user then modifies the enrolled fingerprint feature set uniquely and specifically for each person from whom messages will be received (step 205).

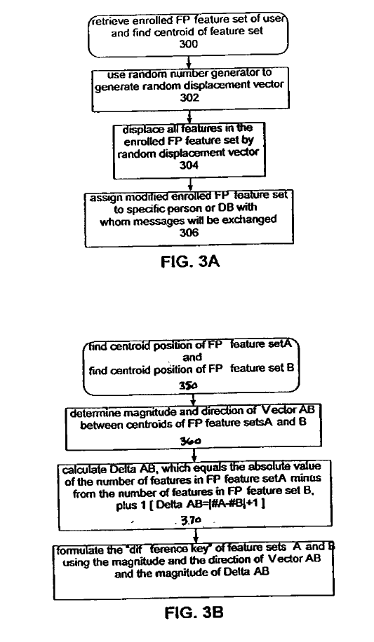

FIG. 3A shows the algorithmic flow chart subroutines for modifying the enrolled fingerprint feature set of the user. Starting with step 300, the centroid of the fingerprint is determined from the relative positions of the features of the fingerprint in the image. A random number is used to generate a displacement vector (step 302) to slightly shift or displace all features of the enrolled fingerprint feature set by a random displacement vector (step 304). The modified enrolled fingerprint feature set is then assigned to a specific person with whom messages will be exchanged (step 308). Many uniquely modified enrolled feature sets, one (or more) for each person with whom messages will be exchanged, may be created and securely stored. Obviously, many other methods may be employed for modifying an enrolled fingerprint feature set such as simply deleting or altering a feature in the set. The objective of modifying the enrolled feature set is to change the feature set uniquely, without significantly compromising the use of the feature set for later fingerprint matching purposes. Optionally, it is also possible to cross-enroll (as outlined in FIG. 2) unmodified enrolled fingerprint feature sets, but this will result in a less secure messaging system (since the same enrolled fingerprint feature set will exist on many computers and thus can be more easily stolen).

FIG. 2 also shows that the first user must establish a private signature key with an associated public signature key, which is sent to the second user (step 207); a message which is encrypted by first user with the private signature key (and thus ‘signed’) may only be decrypted with the associated public signature key, proving that the message originated from the first user.

The second user then receives the public signature key of the first user (step 208); alternatively, the second user may retrieve the public signature key of the first user from a public key server. The second user then checks the validity of the public signature key of the first user (step 209) by comparing it to a list of public keys (if available). The second user must establish a PKI public key with an associated private key (step 210), according to well known means. The second user then sends one (or more) PKI public keys to all persons to whom messages will be sent, including the first user (step 215).

The first user receives the PKI public key from the second user (step 220). The first user then creates an enrollment message (step 222) comprised of the first user's name, the second user's name the uniquely modified enrolled fingerprint feature set (that has been uniquely changed and assigned to the specific second user from whom messages will be received) and a “hash” of some or all of the above information; the hash function any suitable unidirectional hash algorithm such as MD5. The enrollment message is then double encrypted (step 225), firstly with the private signature key of the first user and secondly with the PKI public key of the second user. The first user then sends the double encrypted enrollment message to the second user (step 230).

The second user receives the double encrypted enrollment message of the first user (step 235) and then decrypts it (step 240) firstly with the private key of the second user and secondly with the public signature key of the first user. The second user then checks (step 242) if the first user's name and the second user's name are both correct; the second user also checks the validity of the hash by re-calculating the hash (of the decrypted first and second user names and the modified enrolled fingerprint feature set); if the decrypted hash (from step 240) is identical with the re-calculated hash, then the enrollment message has not been tampered with. The second user then stores the decrypted modified enrolled fingerprint feature set of the first user for later use (step 245).

The algorithmic flow chart shown in FIG. 2 is a general example of one-way cross-enrollment, where the first user provides a modified enrolled fingerprint feature set to the second user. For two-way exchange of messages, the cross-enrollment process of FIG. 2 must be repeated again with first user and second user switching roles, where the second user provides his/her modified enrolled fingerprint feature set to the first user. With symmetrical two-way cross enrollment, both the first user and the second user may send and receive messages that are secured with a biometric certificate, such as a fingerprint.

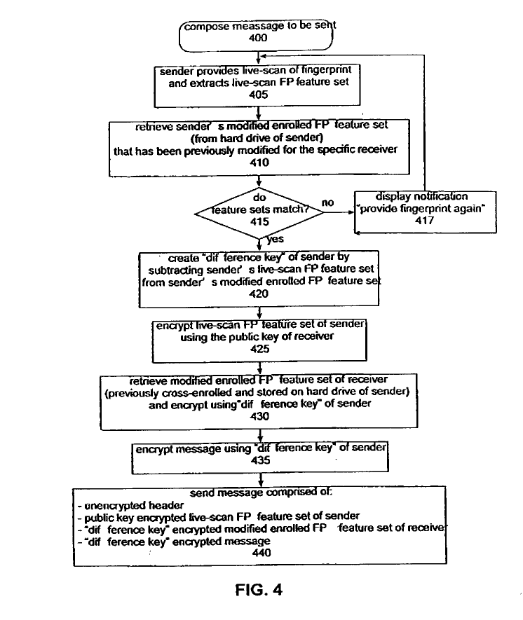

FIG. 4 shows an algorithmic flow chart for sending a message with a fingerprint biometric certificate. For this algorithmic process, it is assumed that both the sender and the receiver have been mutually cross-enrolled, as shown in FIG. 2. The process begins with the sender composing a message to be sent (step 400). The sender next provides a live-scan fingerprint (of a finger that has been previously enrolled) and extracts a new live-scan fingerprint feature set (step 405). The sender next retrieves his/her modified enrolled fingerprint feature set, which has been previously modified for the specific receiver (and cross-enrolled with the specific receiver) (step 410). As an optional test, the sender's live-scan fingerprint feature set can be tested by matching it against the sender's modified enrolled feature set (step 415). If the match is not satisfactory then the sender can be asked to provide a new fingerprint (step 417) and try again for a satisfactory match. Once the match of sender's fingerprint is proven, the “difference key” can be created by subtracting the sender's live-scan fingerprint feature set from the sender's modified enrolled fingerprint feature set (which has been previously cross-enrolled with the receiver) (step 420).

FIG. 3B shows an algorithm flow chart for the subroutine that creates the “difference key” from any two fingerprints, or from any two fingerprint feature sets. The process starts by finding the centroids of each fingerprint feature sets A and B (step 350). Due to near impossibility of placing two fingerprints in exactly the same position on a fingerprint scanner, it is unlikely that the centroids will coincide. The next step 360 is to determine the magnitude and direction of the vector between the centroids of the two fingerprint feature sets, shown as Vector AB. Another simple difference between two fingerprint feature sets is the number of features in each feature set. In step 370, Delta AB is calculated, which is the absolute value of the difference in number of features in two fingerprint feature sets plus one (to ensure a non-zero result). The “difference key” is then formulated for fingerprint feature sets A and B by using the magnitude and direction of Vector AB and the magnitude of Delta AB. The “difference key” can be maintained and used as a matrix of three numbers, or amalgamated into a single number by adding or multiplying (or any other mathematical operation) the three numbers. The objective is that the “difference key” must be a unique number, or set of numbers, deterministically derived from two fingerprints or fingerprint feature sets.

Many other algorithms for calculating a “difference key” are possible, and the algorithm shown in FIG. 3B is by way of example only. Other algorithms for calculating a “difference key” between two fingerprints include, but are not limited to, the following:

1) comparing the relative fingerprint area of two fingerprint feature sets;

2) comparing the average grayscale values of two fingerprint feature sets;

3) comparing the histogram distribution of light and dark pixels in two fingerprints;

4) comparing the relative or absolute ‘jiggle’ in the positions of two or more matched minutiae points in two fingerprints.

It is also possible to use different methods of calculating the “difference key” for different messages or at different times, thus adding to the difficulty of decrypting the message by unauthorized persons.

In FIG. 4, once the “difference key” is created (step 420), the live-scan fingerprint feature set of the sender is encrypted using the public key of the receiver (step 425). The “difference key” of the sender is then used to encrypt the modified enrolled fingerprint feature set of the receiver, which was previously cross-enrolled and stored on the computer of the sender (step 430). The “difference key” is also used to encrypt the message previously composed by the sender (step 435). Finally, the sender transmits the message, comprised of an unencrypted header, the public key encrypted live-scan fingerprint feature set of the sender, the “difference key” encrypted modified enrolled fingerprint feature set of the receiver, and the “difference key” encrypted message (step 440).

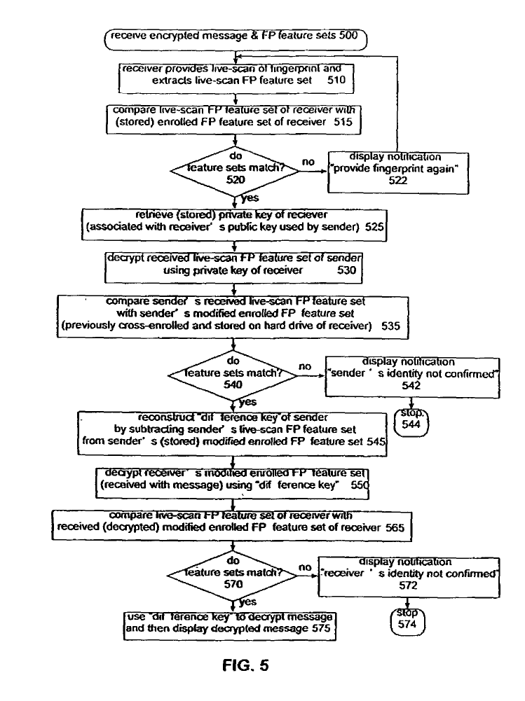

FIG. 5 shows an algorithm flow chart for receiving and decrypting a message sent according to the algorithm shown in FIG. 4. Starting at step 500, the message created at step 440 is received. The receiver then provides a live-scan of a fingerprint and extracts an associated live-scan fingerprint feature set (step 510). The live-scan fingerprint feature set of the receiver is then compared to the stored enrolled feature set of the receiver (step 515). If the fingerprint feature sets do not match, the receiver will be asked to provide a new live-scan fingerprint (step 522). If the receiver's fingerprint feature sets do match, the private key of the receiver is retrieved (step 525) (the private key of the receiver is associated with the public key sent by the receiver to the sender during cross enrollment). The receiver will then use the private key to decrypt the received live-scan fingerprint feature set of the sender (which was previously encrypted by the sender with the public key of the receiver) (step 530). The live-scan fingerprint of the sender is then compared with the sender's modified enrolled fingerprint feature set (which was previously cross-enrolled and stored on the computer of the receiver) (step 535). If the feature sets do not match (step 540), then receiver is notified that the sender's Identity cannot be confirmed (step 542) and the process stops (step 544). If the sender's live-scan and modified enrolled fingerprint feature sets do match, then the “difference key” of the sender is reconstructed (step 545) by subtracting the sender's live-scan fingerprint feature set from the sender's modified enrolled feature set (which was previously cross-enrolled and stored on the computer of the receiver). The reconstructed “difference key” is then used to decrypt the receiver's modified enrolled fingerprint feature set which was received with the message (step 550). Not shown in FIG. 5, the decrypted modified enrolled fingerprint feature set of the receiver can be optionally compared to the stored modified enrolled fingerprint feature set of the receiver (which was previously sent to the specific sender during cross-enrollment); if both feature sets are identical, then sender's identity is again confirmed by a different means than step 640, providing greater security.

In step 565, the decrypted modified enrolled fingerprint feature set of the receiver is then compared with the live-can fingerprint feature set of the receiver (generated in step 510). If the receiver's fingerprint feature sets do not match, then a notification is displayed indicating that the receiver's identity could not be confirmed (steps 570 and 572) and the process stops (step 574). If the receiver's fingerprint feature sets do match, the “difference key” is used to decrypt the sender's message, which is then displayed to the receiver (steps 570 and 575).

Not shown in FIG. 5 for clarity is an optional algorithmic subroutine that gives the sender direct confirmation that the correct person has received the message. The receiver's live-scan fingerprint feature set (generated in step 510) is encrypted, preferably with the “difference key” of the sender (reconstructed in step 545), and transmitted to the sender (after step 575). The sender then decrypts the receiver's live-scan fingerprint feature set with the “difference key” of the sender (originally created in step 420). The decrypted receiver's live-scan fingerprint feature set is then matched with modified enrolled fingerprint feature set of the receiver (which was previously cross-enrolled). A successful match of the live-scan fingerprint feature set of the receiver enables a notification to be displayed to the sender that the message has been received and decrypted by the proper person.

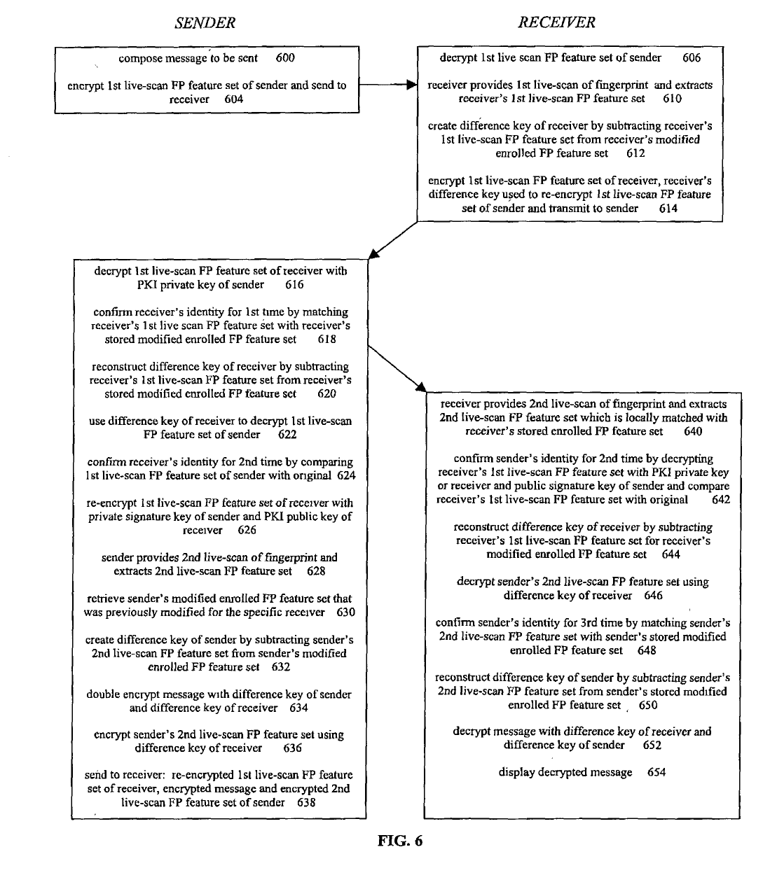

FIG. 6 shows an algorithm flow chart for sending and receiving a biometrically certified message with higher security protection than shown in FIGS. 4 and 5. The algorithm shown in FIG. 6 requires cross-enrollment of modified enrolled feature sets, as shown in FIG. 2. The algorithm shown in FIG. 6 is structured as a multi-part “handshake” between the sender and receiver, whereby the sender initiates the process (of steps 600-604) of sending a message, the receiver responds (with steps 606-614) indicating readiness to receive a message, the sender prepares and sends (with steps 616-638) the biometrically encrypted message, and the receiver decrypts (with steps 640-654) the message. The benefit of increased algorithmic complexity (where two fingerprints of the sender and two fingerprints of the receiver are required) is increased security. Two “difference keys” are utilized (of the sender and receiver) and the receiver's identity is confirmed twice and the sender's identity is confirmed three times.

FIG. 6 shows the sender composing a message to be sent (step 600). The sender then provides a first live-scan fingerprint and extracts the first live-scan fingerprint feature set which is then encrypted with the public key of the receiver and sent to the receiver (step 604). This process announces to the receiver that the sender wishes to send a biometrically certified message.

The receiver then decrypts the sender's first live scan fingerprint feature set with the private key of the receiver (step 606). The sender's identity is confirmed for the first time by matching the sender's first live-scan fingerprint feature set with the sender's stored modified enrolled feature set (which exchanged during cross-enrollment). The receiver then provides a first live-can fingerprint and extracts the receiver's first live-scan fingerprint feature set (step 610). The first “difference key” of the receiver is created by subtracting the receiver's first live-scan fingerprint feature set from the receiver's modified enrolled fingerprint feature set (step 612). The public key of the sender is used to encrypt the receiver's first live-scan fingerprint feature set, and the receiver's “difference key” is used to re-encrypt the first live-scan fingerprint feature set of the sender; both encrypted feature sets are then transmitted to the sender (step 614).

The sender then decrypts the first live-scan fingerprint feature set of the receiver with the private key of the sender (step 616). The sender then confirms the receiver's identity (for the first time) by matching the first live-scan fingerprint feature set of the receiver with the stored modified enrolled fingerprint feature set of the receiver (which was previously cross-enrolled with the sender) (step 618). The “difference key” of the receiver is then reconstructed by subtracting the first live-scan fingerprint feature set of the receiver from the stored modified enrolled fingerprint feature set of the receiver (step 620). The “difference key” of the receiver is then used to decrypt the first live-scan fingerprint feature set of the sender (which was previously re-encrypted 614 by the receiver) (step 622). The sender then confirms receiver's identity (for the second time) by comparing the decrypted first live-scan fingerprint feature set of the sender with the original (which was previously extracted 602) (step 624). The sender then re-encrypts the first live-scan fingerprint feature set of the receiver with the public key of the receiver (for later transmission back to the receiver) (step 626). The sender then provides a second live-scan fingerprint and extracts the second live-scan fingerprint feature set of the sender (step 628). The sender then retrieves the modified enrolled fingerprint feature set of the sender that was previously modified for the specific receiver (and cross-enrolled with the receiver) (step 630). The “difference key” of the sender is then created by subtracting the second live-scan fingerprint feature set of the sender from the modified enrolled fingerprint feature set of the sender that was previously modified for the specific receiver (step 632). The “difference key” of the sender is then used to encrypt the message (originally composed at step 600 by the sender) (step 634). The “difference key” of the sender is also used to encrypt the second live-scan fingerprint feature set of the sender (step 636). Finally, the sender transmits to the receiver the re-encrypted first live-scan fingerprint feature set of the receiver (previously re-encrypted with the receiver's public key at step 626) (step 638), the encrypted message (previously encrypted with the “difference key” of the sender at step 634), and the encrypted second live-scan fingerprint feature set of the sender (previously encrypted with the “difference key” of the sender at step 636).

When the receiver receives transmission, the receiver provides a second live-scan fingerprint (step 638) and extracts a second live-scan fingerprint feature set, which is then matched against the stored fingerprint feature set of the receiver (the receiver must prove his/her identity for the decryption process to continue) (step 640). The identity of the sender is then confirmed (for the second time) by using the private key of the receiver to decrypt the receiver's first live-scan fingerprint feature set (previously re-encrypted at step 626) and comparing it with the original (generated previously at step 610) (step 642). The “difference key” of the receiver is then reconstructed by subtracting the receiver's first live-scan fingerprint feature set (previously decrypted at step 642) from the receiver's modified enrolled fingerprint feature set (previously cross-enrolled with the specific sender) (step 644). The “difference key” of the receiver could also be recalled from the original create at step 612, but reconstructing it adds additional security. The “difference key” of the receiver is then used to decrypt the sender's second live-scan fingerprint feature set (previously created at step 628 and encrypted at step 636) (step 646). The sender's identity is then confirmed (for a third time) by matching the sender's second live-scan fingerprint feature set with the sender's stored modified enrolled fingerprint feature set (previously cross-enrolled) (step 648). The “difference key” of the sender is then reconstructed by subtracting the sender's second live-scan fingerprint feature set from the sender's stored modified enrolled fingerprint feature set (step 650). The “difference key” of the sender is then used to decrypt the message (previously encrypted at step 634) (step 652). The message is then finally displayed to the receiver (step 654).

Not shown in FIG. 6 for clarity is an optional algorithmic subroutine that gives the sender direct confirmation that the correct person has received the message. The receiver's second live-scan fingerprint feature set (generated in step 640) is encrypted, preferably with the “difference key” of the sender (reconstructed in step 650), and transmitted to the sender (after step 654). The sender then decrypts the receiver's second live-scan fingerprint feature set with the “difference key” of the sender (created in step 632); the decrypted receiver's second live-scan fingerprint feature set is then matched with the modified enrolled fingerprint feature set of the receiver (which was previously cross-enrolled and used in step 620). A successful match of the second live-scan fingerprint feature set of the receiver enables a notification to be displayed to the sender that the message has been received and decrypted by the proper person.

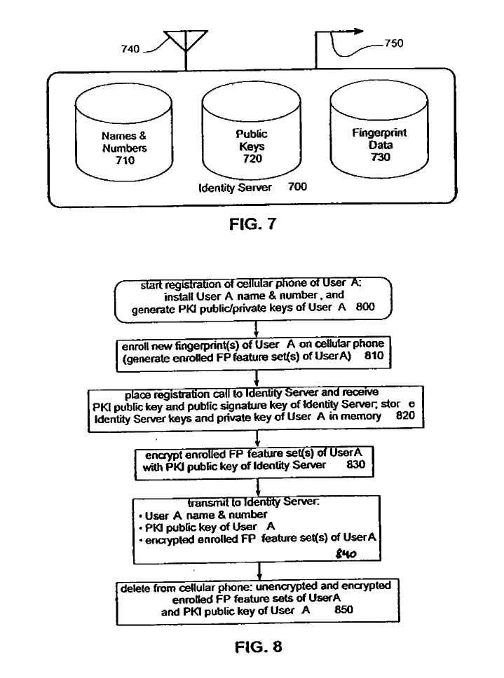

FIGS. 7, 8 and 9 show an embodiment of the invention applied to a cellular telephone network. The purpose of this embodiment is provide biometrically secure communications of voice audio and other data over cellular telephones.

FIG. 7 shows an Identity Server database 700 on a cellular telephone network. The purpose of Identity Server is to provide confirmation of the identity of cellular telephone users, in place of cross-enrollment procedure shown in FIG. 2. The Identity Server has several databases, including names and numbers of users 710, public keys of users 720 and enrolled fingerprint feature sets (or other biometric information) of users 730. The Identity Server is connected to cellular telephone users via the standard radio frequency links 740. The Identity Server may also connected with users, other servers, and other information services via any other available electronic communications links 750 such as cable, fiber optic and/or microwave relays.

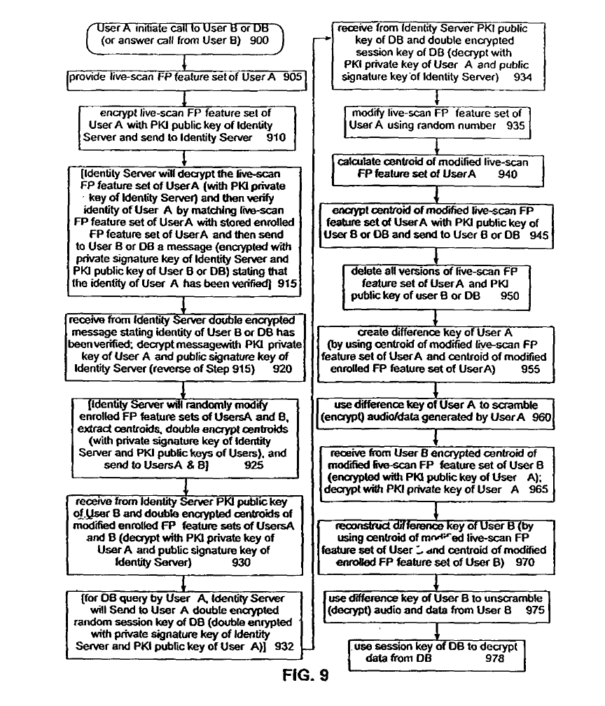

FIG. 8 shows the algorithm flow chart for registering a single cellular telephone of User A on the Identity Server of a cellular network (for example, at the time of purchase). The process starts (step 800) by installing the name and number of User A on the telephone; the cellular telephone then automatically generates the PKI public and private keys (or any other asymmetric public/private key pair system) of User A (by well known mathematical processes). [Alternatively the PKI public and private keys of User A may be generated elsewhere downloaded onto the cellular telephone; alternatively the PKI public and private keys of User A may be stored on a ‘smart card’ or other external storage device which can be connected to the cellular telephone.] User A then presents one or more fingerprints (or other biometric) and an enrolled FP (fingerprint) feature set(s) of User A is then automatically generated (step 810). A call is then placed (step 820) to the Identity Server and the PKI public key and the public signature key (used later to verify that messages originate from the Identity Server) of the Identity Server are received and stored in the nonvolatile memory of the cellular telephone; the private key of User A is also stored in nonvolatile memory. The enrolled FP feature set(s) of User A are then encrypted with the PKI public key of the Identity Server (step 830). The cellular telephone of User A then transmits to the Identity Server (step 840) the name and number of User A, the PKI public key of User A and the encrypted enrolled FP feature set of User A; the Identity Server then stores this information about User A in the appropriate databases. Finally, the unencrypted and encrypted feature sets of User A, and the PKI public key of User A are then deleted (step 850) from the memory of the cellular telephone of User A, leaving no biometric information in the memory of the cellular telephone.

FIG. 9 shows the algorithm flow chart for initiating or receiving a biometrically secure call (step 900) on the cellular telephone of User A. User A first provides a fingerprint and generates a live-scan FP feature set (step 905). The live-scan FP feature set of User A is then encrypted with the PKI public key of the Identity Server and the encrypted FP feature set is then transmitted (step 910) to the Identity Server. The Identity Server then verifies the identity of User A by matching the live-scan FP feature set of User A with stored enrolled FP feature set of User A, and then sends to User B a message (encrypted with private signature key of Identity Server and PKI public key of User B) stating that the identity of User A has been verified (step 915). User A then receives from Identity Server (step 920) a double encrypted message stating that the identity of User B has been verified; the message is then decrypted with PKI private key of User A and public signature key of the Identity Server (reverse of Step 915). The Identity Server will then randomly modify the enrolled FP feature sets of Users A and B, extract centroids (and/or other derived information subsets such such as minutiae counts, etc.), double encrypt centroids (with private signature key of Identity Server and PKI public keys of Users), and send the encrypted centroids to Users A and B (step 925). [Alternatively, the Identity Server can extract the centroids (or other derived information subsets about the FP feature sets) of the FP feature sets and then randomly modify the centroids and then double encrypt the centroids and send the encrypted centroids to both of the users.] User A will then receive (step 930) from the Identity Server the double encrypted centroids of modified enrolled FP feature sets of Users A and 8, and the PKI public key of User B (all encrypted with the private signature key of Identity Server and the PKI public key of User A); User A will then decrypt the centroids of Users A and B and the PKI public key of User B with PKI private key of User A and with the public signature key of Identity Server. Optionally, all messages from the Identity Server may be additionally hashed (by a hash algorithm such as MD5); User A may re-hash the decrypted message from the Identity Server and compare it to the transmitted hash; an exact match of the of the rehash with the transmitted hash ensures that messages from the Identity Server have not been tampered with.

Steps 935 through 960 of FIG. 9 shows the algorithmic sequence used to create the “difference key” of User A, which is used to scramble (by ‘streaming encryption’) the digital audio and other data generated by the cellular telephone of User A. The live-scan FP feature set of User A is modified (step 935) using a random number (derived, for example, from the number of minutiae in the fingerprint and/or the time taken to gather the fingerprint); the modification of the live-scan FP feature set of User A is similar to the algorithm shown in FIG. 3a and prevents the Identity Server from being able to decrypt speech and messages from User A. Next, the centroid (and/or, optionally, other derived information subsets such as minutiae count) of the modified live-scan FP feature set of User A is calculated (step 940). [Alternatively to steps 935 and 940, centroid (or other information subset) of the live-scan FP feature set of User A could be calculated first, and then modified using a random number.] The centroid of the modified live-scan FP feature set of User A is then encrypted (step 945) with the PKI public key of User B and sent to User B. All versions of the live-scan FP feature set of User A and the public key of User B are deleted (step 950) from the memory of the cellular telephone, leaving no biometric information in the cellular telephone of User A. The “difference key” of User A is then created (step 955) by calculating the difference between the centroids (and/or other derived information subsets) of the modified live-scan FP feature set of User A and the modified enrolled FP feature sets of User A (using an algorithm similar to that shown in FIG. 3B). The “difference key” of User A is then used for streaming encryption (or real time scrambling) (step 960) of the audio speech or other data generated by User A.

Steps 965 through 975 of FIG. 9 shows the algorithmic sequence used to create the “difference key” of User B, which is used to unscramble (by ‘streaming decryption’) the digital audio and other data generated by the cellular telephone of User B. User A receives (step 965) from User B the encrypted centroid of the modified live-scan FP feature set of User B, which has been encrypted with the PKI public key of User A; User A then decrypts the centroid of the modified live-scan FP feature set of User B with the PKI private key of User A. The “difference key” of User B is then reconstructed (step 970) by calculating the difference between the centroids (and/or other derived information subsets) of the modified live-scan FP feature set of User B and the modified enrolled FP feature set of User B (using an algorithm similar to that shown in FIG. 3B). Finally, the “difference key” of User B is used for streaming decryption (unscrambling) the audio and other data received from User B.

The above descriptions are examples of methods to implement biometric certificates derived from the biometric information of fingerprints, as a means to increase the security of electronic messaging by requiring the physical identity of both the sender and the receiver to be confirmed. Any other biometric information is contemplated by the present invention, such as iris eye patterns. The above descriptions of method can also include additional security means, such as secret passwords, secret personal identification numbers (PIN numbers), physical keys or cards, serial numbers of biometric input devices and time stamps at the time of message origin. The above descriptions employ common asymmetric public/private key technology for convenience only; it is equally possible to implement biometric certificates by the use of secret keys that are securely exchanged between the sender and receiver by other means. Furthermore, although email by means of the Internet is used by way of example, the disclosed methods and techniques of biometric certificates are employable with other information transport mechanisms (e.g. wireless communications protocols and broadband communication protocols).

What is claimed is:

1. A method for exchanging electronic messages between a sender with an enrolled biometric feature set and a receiver with an enrolled biometric feature set, comprising:
a. exchanging enrolled biometric feature sets between the sender and receiver;
b. generating a live-scan biometric feature set of the sender;
c. generating a first difference key derived from the difference between the sender's live-scan biometric feature set and the sender's enrolled biometric feature set;
d. encrypting the message with the first difference key;
e. encrypting said sender's live-scan biometric feature set with an encryption key;
f. transmitting to the receiver the encrypted message and said encrypted sender's live-scan biometric feature set;
g. decrypting by the receiver said encrypted sender's live-scan biometric feature set;
h. regenerating by the receiver the first difference key by calculating the difference between said sender's live-scan biometric feature set and the sender's enrolled biometric feature set;
i. decrypting the message by use of the regenerated first difference key.

2. The method of claim 1, wherein the biometric feature set is a fingerprint feature set.

3. The method of claim 1, further comprising the steps of:
a. modifying the enrolled biometric feature set of a sender or receiver such that it is unique but still useful for the purposes of matching other biometric feature sets of the person to identify the individual;
b. modifying multiple enrolled biometric feature sets such that each biometric feature set is unique;
c. assigning one or more uniquely modified enrolled biometric feature sets to specific individuals with whom messages will be exchanged;
d. securely exchanging unique modified enrolled biometric feature sets with individuals with whom messages will be exchanged.

4. The method of claim 2 whereby public key cryptographic techniques are used to securely exchange modified enrolled biometric feature sets.

5. The method of claim 1, further comprising:
a. generating a real-time biometric feature set by the sender during message exchange to assert the identity of the sender;
b. generating a real-time biometric feature set by the receiver during message exchange to assert the identity of the receiver;
c. validating the identity of the sender during message exchange;
d. validating the identity of the receiver during message exchange.

6. The method of claim 1, further comprising:
a. determining the characteristics a first biometric feature set;
b. determining the characteristics a second biometric feature set;
c. determining the differences between said characteristics of first and second biometric feature sets;
d. creating an encryption/decryption key based on said differences.

7. The method of claim 1, further comprising:
a. using the differences between a real-time biometric feature set and enrolled biometric feature set to create a unique encryption/decryption key;
b. using the unique encryption/decryption key to encrypt data during message exchange;
c. securely exchanging real-time biometric feature sets by one or more parties during message exchange;
d. reconstructing the unique encryption/decryption key by a remote party by using the differences between the characteristics of the exchanged real-time biometric feature set and the previously exchanged enrolled biometric feature set;
e. using the unique encryption/decryption key by a remote party to decrypt the data sent with the message.

8. The method of claim 1 further comprising the transmission of the encrypted receiver's biometric feature set to the sender, allowing the sender to confirm that the proper person has received the message.

9. The method of claim 1, further comprising the steps of:
a. generating one or more live-scan biometric feature sets of the receiver during the process of receiving messages;
b. generating a second difference key derived from the difference between the receiver's live-scan biometric feature set and the receiver's enrolled biometric feature set;
c. encrypting data by the receiver with the second difference key and transmission of encrypted data from the receiver to the sender;
d. confirming the identity of the receiver by the sender by decrypting the live-scan biometric feature set of the receiver and matching against the enrolled biometric feature set of the receiver;
e. confirming the identity of the receiver by reconstructing the second difference key, decrypting data from the receiver, and confirming the validity of the data;
f. encrypting data by the sender with the first difference key;
g. transmitting to the receiver of the encrypted data;
h. decrypting by the receiver of the sender's live-scan biometric feature set to check the identity of the sender;
wherein exchanging the enrolled biometric feature sets between the sender and receiver occurs prior to the exchange of messages; and generating the live-scan biometric feature set of the sender occurs during the process of sending messages.

10. The method of claim 9, wherein the biometric feature set is a fingerprint feature set.

11. The method of claim 9, further comprising:
a. enrolled biometric feature set of an individual who wishes to send or receive messages;
b. modifying the enrolled biometric feature set such that it unique but still useful for the purposes of matching other biometric feature sets of the individual and thus to identify or verify the identity of the individual;
c. modifying of multiple enrolled biometric feature sets such that each biometric feature set is unique;
e. assigning one or more uniquely modified enrolled biometric feature sets to specific individuals with whom messages will be exchanged;
f. securely exchanging unique modified enrolled biometric feature sets with individuals with whom messages will be exchanged.

12. The method of claim 9 whereby public key cryptographic techniques are used to securely exchange modified enrolled biometric feature sets.

13. The method of claim 9, further comprising:
a. generating a real-time biometric feature set by the sender during message exchange to assert the identity of the sender;
b. generating a real-time biometric feature set by the receiver during message exchange to assert the identity of the receiver;
c. validating the identity of the sender during message exchange;
d. validating the identity of the receiver during message exchange.

14. The method of claim 9, further comprising:
a. determining the characteristics a first biometric feature set;
b. determining the characteristics a second biometric feature set;
c. comparing the characteristics of the first and second biometric feature sets;
d. determining the differences between the characteristics of the first and second biometric feature sets;
e. creating an encryption/decryption key based on the differences between the characteristics of the first and second biometric feature sets.

15. The method of claim 9, further comprising:
a. using the differences between a real-time biometric feature set and enrolled biometric feature set to create a unique encryption/decryption key;
b. using the unique encryption/decryption key to encrypt a message for message exchange;
c. securely exchanging real-time biometric feature sets by one or more parties during message exchange;
d. reconstructing the unique encryption/decryption key by a remote party by using the differences between the characteristics of the exchanged real-time biometric feature set and the previously exchanged enrolled biometric feature set;
e. using the unique encryption/decryption key by a remote party to decrypt the data sent with the message.

16. The method of claim 9 further comprising the steps of transmitting the encrypted receiver's biometric feature set to the sender so that the sender confirms that the proper person has received the message.

17. A system for exchanging electronic messages between a sender with an enrolled biometric feature set and a receiver with an enrolled biometric feature set, comprising:
a. means for exchanging enrolled biometric feature sets between the sender and receiver;
b. means for generating a live-scan biometric feature set of the sender;
c. means for generating a difference key derived from the difference between the sender's live-scan biometric feature set and the sender's enrolled biometric feature set;
d. means for encrypting the message with the difference key;
e. means for encrypting said sender's live-scan biometric feature set with an encryption key;
f. means for transmitting to the receiver the encrypted message and said encrypted sender's live-scan biometric feature set;
g. means for decrypting by the receiver said encrypted sender's live scan biometric feature set;
h. means for regenerating by the receiver the difference key by calculating the difference between said sender's live-scan biometric feature set and the sender's enrolled biometric feature set; means for decrypting the message by use of the regenerated difference key.
